(19) United States
(12) Patent Application Publication
(10) Pub. No.: US 2023/0335862 A1
(43) Pub. Date: Oct. 19, 2023

(54) IMPROVED MEMBRANES WITH NANOPARTICLE INORGANIC FILLER

(71) Applicant: Ceigard, LLC, Charlotte, NC (US)

(72) Inventors: Wenbin Yin, Charlotte, NC (US); Jing Jin, Maryland Heights, MO (US)

(21) Appl. No.: 18/010,420

(22) PCT Filed: Jun. 17, 2021
(86) PCT No.: PCT/US2021/037720

§ 371 Date: Dec. 14, 2022

Related U.S. Application Data
(60) Provisional application No. 63/040,543, filed on Jun. 18, 2020.

(51) Int. Cl. H01M 50/457; H01M 50/446; H01M 50/491; H01M 50/403; H01M 10/0525; H01M 50/417

(52) U.S. Cl. CPC H01M 50/457; H01M 50/446; H01M 50/491; H01M 50/403; H01M 10/0525; H01M 50/417

(57) ABSTRACT

A multilayer battery separator comprises a first outer layer comprising a blend of a polypropylene and a first nanoparticle inorganic filler; and a second outer layer laminated to the first outer layer.

### CROSS REFERENCE TO RELATED APPLICATIONS

This application is a 371 U.S. Application claiming priority to PCT/US2021/037720, filed Jun. 17, 2021, which claims priority to U.S. Provisional Patent application Ser. No. 63/040,543, filed Jun. 18, 2020, which is hereby fully incorporated by reference herein.

### FIELD OF THE INVENTION

In accordance with at least selected embodiments, the application, disclosure or invention relates to membranes, separator membranes, separators, battery separators, secondary lithium battery separators, multilayer membranes, multilayer separator membranes, multilayer separators, multilayer battery separators, multilayer secondary lithium battery separators, multilayer battery separators, batteries, capacitors, fuel cells, lithium batteries, lithium ion batteries, secondary lithium batteries, and/or secondary lithium ion batteries, and/or methods for making and/or using such membranes, separator membranes, separators, battery separators, secondary lithium battery separators, batteries, capacitors, fuel cells, lithium batteries, lithium ion batteries, secondary lithium batteries, and/or secondary lithium ion batteries, and/or devices, vehicles or products including the same, and/or methods for testing, quantifying, characterizing, and/or analyzing such membranes, separator membranes, separators, battery separators, and the like. In accordance with at least certain embodiments, the disclosure or invention relates to membrane layers, membranes or separator membranes, battery separators including such membranes, and/or related methods. In accordance with at least certain selected embodiments, the disclosure or invention relates to porous polymer membranes or separator membranes, battery separators including such membranes, and/or related methods. In accordance with at least particular embodiments, the disclosure or invention relates to microporous polyolefin membranes or separator membranes, microlayer membranes, multi-layer membranes including one or more microlayer or nanolayer membranes, battery separators including such membranes, and/or related methods. In accordance with at least certain particular embodiments, the disclosure or invention relates to microporous stretched polymer membranes or separator membranes having one or more exterior layers and/or interior layers, microlayer membranes, multi-layered microporous membranes or separator membranes having exterior layers and interior layers, some of which layers or sublayers are created by co-extrusion and then laminated together to form the membranes or separator membranes. In some embodiments, certain layers, microlayers or nanolayers can comprise a homopolymer, a copolymer, block copolymer, and/or elastomer, blended with an inorganic nanoparticle filler. In select embodiments, at least certain layers, microlayers or nanolayers can comprise a different or distinct polymer, homopolymer, copolymer, block copolymer, and/or elastomer blended with an inorganic nanoparticle filler. The disclosure or invention also relates to methods for making such a membrane, separator membrane, or separator, and/or methods for using such a membrane, separator membrane or separator, for example as a lithium battery separator. In accordance with at least selected embodiments, the application or invention is directed to multi-layered and/or microlayer porous or microporous membranes, separator membranes, separators, composites, electrochemical devices, and/or batteries, and/or methods of making and/or using such membranes, separators, composites, devices and/or batteries. In accordance with at least particular selected embodiments, the application or invention is directed to separator membranes that are multi-layered, in which one or more layers of the multi-layered structure is produced in a multi-layer or microlayer co-extrusion die with multiple extruders. The membranes, separator membranes, or separators can demonstrate improved thermal stability, increased film toughness, improved electrolyte uptake, and/or improved pin-removal properties.

### BACKGROUND

Polypropylene-containing separators have two intrinsic limitations in lithium ion batteries. One limitation is the poor wettability with organic electrolyte, which in turn, generates high ionic conduction resistance in the separator layers. The other limitation is a high static force that cause high pin-removal force during winding. Various attempts to improve these properties have been explored, such as the use of ceramic or polymer coating. The idea behind these attempts is that such ceramic or polymer coatings will improve ion transport and electrolyte uptake, decreasing ionic conduction resistance and static forces. Additionally, these ceramic or polymer coatings are believed to act as anti-blocking agents, which helps to minimize film to film surface contact, thereby minimizing adhesion. However, these approaches have only provided marginal improvements at an increased manufacturing cost.

Improved polypropylene-containing separators that have good wettability and low ionic conduction resistance, reduced adhesion, and/or lower manufacturing costs is still needed.

### SUMMARY

In accordance with at least selected embodiments, the application, disclosure or invention relates to membranes, separator membranes, separators, battery separators, secondary lithium battery separators, multilayer membranes, multilayer separator membranes, multilayer separators, multilayer battery separators, multilayer secondary lithium battery separators, multilayer battery separators, batteries, capacitors, fuel cells, lithium batteries, lithium ion batteries, secondary lithium batteries, and/or secondary lithium ion batteries, and/or methods for making and/or using such membranes, separator membranes, separators, battery separators, secondary lithium battery separators, batteries, capacitors, fuel cells, lithium batteries, lithium ion batteries, secondary lithium batteries, and/or secondary lithium ion batteries, and/or devices, vehicles or products including the same, and/or methods for testing, quantifying, characterizing, and/or analyzing such membranes, separator membranes, separators, battery separators, and the like. In accordance with at least certain embodiments, the disclosure or invention relates to membrane layers, membranes or separator membranes, battery separators including such membranes, and/or related methods. In accordance with at least certain selected embodiments, the disclosure or invention relates to porous polymer membranes or separator membranes, battery separators including such membranes, and/or related methods. In accordance with at least particular embodiments, the disclosure or invention relates to microporous polyolefin membranes or separator membranes, microlayer membranes, multi-layer membranes including one or more microlayer or nanolayer membranes, battery separators including such membranes, and/or related methods. In accordance with at least certain particular embodiments, the disclosure or invention relates to microporous stretched polymer membranes or separator membranes having one or more exterior layers and/or interior layers, microlayer membranes, multi-layered microporous membranes or separator membranes having exterior layers and interior layers, some of which layers or sublayers are created by co-extrusion and then laminated together to form the membranes or separator membranes. In some embodiments, certain layers, microlayers or nanolayers can comprise a homopolymer, a copolymer, block copolymer, and/or elastomer, blended with an inorganic nanoparticle filler. In select embodiments, at least certain layers, microlayers or nanolayers can comprise a different or distinct polymer, homopolymer, copolymer, block copolymer, and/or elastomer blended with an inorganic nanoparticle filler. The disclosure or invention also relates to methods for making such a membrane, separator membrane, or separator, and/or methods for using such a membrane, separator membrane or separator, for example as a lithium battery separator. In accordance with at least selected embodiments, the application or invention is directed to multi-layered and/or microlayer porous or microporous membranes, separator membranes, separators, composites, electrochemical devices, and/or batteries, and/or methods of making and/or using such membranes, separators, composites, devices and/or batteries. In accordance with at least particular selected embodiments, the application or invention is directed to separator membranes that are multi-layered, in which one or more layers of the multi-layered structure is produced in a multi-layer or microlayer co-extrusion die with multiple extruders. The membranes, separator membranes, or separators can demonstrate improved thermal stability, increased film toughness, improved electrolyte uptake, and/or improved pin-removal properties.

In an aspect, a multilayer battery separator membrane comprises a first outer layer comprising a blend of a polypropylene and a first nanoparticle inorganic filler; a second outer layer laminated to the first outer layer. The polypropylene first outer layer can comprise a polypropylene, a polypropylene blend, a polypropylene copolymer, or any combination thereof. In some embodiments, the second outer layer is a polyolefin composition comprising a polypropylene, a polypropylene blend, a polypropylene copolymer, a polyethylene, a polyethylene blend, a polyethylene copolymer, a polyvinylidene fluoride (PVDF), a polyethylene oxide (PEO), a poly(methyl methacrylate) (PMMA), or any combination thereof.

In some embodiment, a first nanoparticle inorganic filler described herein comprises CaSO₄, CaCO₃, TiO₂, SiO₂, SiO, or any combination thereof. The first nanoparticle inorganic filler can have an average pore size of 2-15 nm. In some cases, a ratio of first nanoparticle inorganic filler polypropylene to comprises 0.1-10%, respectively. The first nanoparticle inorganic filler can have an average size in three dimensions of 50-300 nm in some instances. In some embodiments, the first nanoparticle inorganic filler has an average pore size of 2-15 nm.

In some instances, the blend of polypropylene and first nanoparticle inorganic filler is coextruded.

The second outer layer of the multilayer battery separator membrane can comprise a blend of a polypropylene and a second nanoparticle inorganic filler in some instances. The first nanoparticle inorganic filler and the second nanoparticle inorganic filler can be of the same type in some instances, and in other instances the first nanoparticle inorganic filler and the second nanoparticle inorganic filler are different types. In some embodiments, the second nanoparticle inorganic filler comprises CaSO₄, CaCO₃, TiO₂, SiO₂, SiO, or any combination thereof.

In some cases, a multilayer battery separator membrane described herein can further comprise one or more inner layers positioned between the first outer layer and the second outer layer. One of the inner layers comprises a polyethylene, a polyethylene blend, a polyethylene copolymer, a polypropylene, a polypropylene blend, a polypropylene copolymer, a polyvinylidene fluoride (PVDF), a polyethylene oxide (PEO), a poly(methyl methacrylate) (PMMA), or any combination there.

In some embodiment, one or more inner layers are free of a nanoparticle inorganic filler. In other embodiments, one or more inner layers are blended with a nanoparticle inorganic filler. In some cases when a plurality of inner layers are present, one or more of the inner layers are free of the nanoparticle inorganic filler, and one or more of the inner layers are blended with the nanoparticle inorganic layer. When present in the inner layers, the nanoparticle inorganic filler can be present in an amount less than 10 wt. % based on a total weight of the inner layer.

In some embodiments, the one or more inner layers comprise one or more polypropylene inner layers positioned between the first outer layer and the second outer layer. In some cases, one or more of the polypropylene inner layers are free of a nanoparticle inorganic filler; and one or more of the other polypropylene inner layers are blended with a nanoparticle inorganic filler.

In some instances, multilayer battery separator membrane has a porosity in the range of 35% to 65%.

In another aspect, a method of making a multilayer battery separator membrane comprises extruding a dry process nonporous precursor blend of a polypropylene and a nanoparticle inorganic filler to form a first outer layer; extruding a dry process nonporous precursor polypropylene optionally comprising a blended nanoparticle inorganic filler to form a second outer layer; laminating the first outer layer to the second outer layer to form a nonporous laminated membrane precursor; annealing the nonporous laminated membrane precursor; and stretching the annealed nonporous laminated membrane precursor.

In some cases, a method of making a multilayer battery separator membrane described herein comprises extruding a dry process nonporous precursor blend of a polypropylene (PP) and a nanoparticle inorganic filler to form at least one outer layer; extruding a dry process nonporous inner layer precursor optionally comprising a blended nanoparticle inorganic filler to form an inner layer; laminating the outer layers to opposite sides of the one or more inner layers to form a nonporous laminated membrane precursor; annealing the nonporous laminated membrane precursor; and stretching the annealed nonporous laminated membrane precursor to form a laminated microporous multilayer battery separator membrane.

The inner layer precursor comprises polypropylene (PP), polyethylene (PE), polyvinylidene fluoride (PVDF), polyethylene oxide (PEO), poly(methyl methacrylate) (PMMA), or any combination there in some cases.

In some embodiments, a laminated microporous multilayer battery separator membrane described herein produced by the methods described herein has a configuration of PP/PE/PP, PP/PE/PP/PE/PP, PP/PE/PE/PP, and/or PP/PP/PE/PP/PP.

In an aspect, a lithium ion battery comprises a multilayer battery separator membrane described herein. In another aspect, a device comprises the lithium ion battery.

### BRIEF DESCRIPTION OF THE DRAWINGS

FIG. 1 shows an embodiment of a tri-layer membrane 10 having a first outer layer 1 comprising PP+first inorganic nanoparticles, an inner layer 2 comprising a polyolefin without any inorganic nanoparticles, and a second outer layer 3 comprising a polyolefin without any inorganic nanoparticles.

FIG. 2 shows an embodiment where the first outer layer 1 and the second outer layer 3 both comprise PP+first inorganic nanoparticles, and an inner layer 2 comprising a polyolefin without any inorganic nanoparticles.

FIG. 3 shows an embodiment where the first outer layer 1 comprises PP+first inorganic nanoparticles, an inner layer 2 comprising a polyolefin without any inorganic nanoparticles, and a second outer layer 3 that comprises PP+second inorganic nanoparticles, the first and second inorganic nanoparticles being different.

FIG. 4 shows an embodiment where the first outer layer 1 and the second outer layer 3 both comprise PP+first inorganic nanoparticles, and an inner layer 2 comprising a PE without any inorganic nanoparticles.

FIG. 5 shows an embodiment where the first outer layer 1 comprises PP+first inorganic nanoparticles, an inner layer 2 comprising PE without any inorganic nanoparticles, and a second outer layer 3 that comprises PP+second inorganic nanoparticles, the first and second inorganic nanoparticles being different.

FIG. 6 shows a 5-layer embodiment comprising a structure of PP/PE/PP/PE/PP, where first outer layer 1 comprises PP+first inorganic nanoparticles, the PE/PP/PE inner layers 2 comprise a PP layer that optionally comprises first or second inorganic nanoparticles and two PE layers free of any inorganic nanoparticles, and a second outer layer 3 that comprises PP and optionally comprises first or second inorganic nanoparticles.

FIG. 7 shows a 4-layer embodiment comprising a structure of PP/PE/PE/PP, where the first outer layer 1 comprises PP+first inorganic nanoparticles, the two PE inner layers 2 are free of inorganic nanoparticles, and the second outer layer 3 comprises PP and optionally comprises first or second inorganic nanoparticles.

FIG. 8 shows a 5-layer embodiment comprising a structure of PP/PP/PE/PP/PP, where the first outer layer 1 comprises PP+first inorganic nanoparticles, the two PP inner layers 2 optionally comprise first or second inorganic nanoparticles, the PE inner layer 2 is free of inorganic nanoparticles, and the second outer layer 3 comprises PP and optionally comprises first or second inorganic nanoparticles.

FIG. 9 is a diagram of an exemplary co-extrusion process.

FIG. 10 is an exploded diagram of an exemplary co-extrusion die.

### DETAILED DESCRIPTION

Embodiments described herein can be understood more readily by reference to the following detailed description and examples. Elements, apparatus and methods described herein, however, are not limited to the specific embodiments presented in the detailed description and examples. It should be recognized that these embodiments are merely illustrative of the principles of the present disclosure. Numerous modifications and adaptations will be readily apparent to those of skill in the art without departing from the spirit and scope of the disclosure.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, such as 1.0 to 5.3, or 4.7 to 10.0, or 3.6 to 7.9.

All ranges disclosed herein are also to be considered to include the end points of the range, unless expressly stated otherwise. For example, a range of “between 5 and 10,” “from 5 to 10,” or “5-10” should generally be considered to include the end points 5 and 10.

Further, when the phrase “up to” is used in connection with an amount or quantity, it is to be understood that the amount is at least a detectable amount or quantity. For example, a material present in an amount “up to” a specified amount can be present from a detectable amount and up to and including the specified amount.

The terms “membrane,” “film” and “separator” are used interchangeably herein, and unless expressly specified, are to be interpreted as having the same meaning.

Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

Polypropylene separators have two intrinsic limitations in lithium ion batteries. One limitation is the poor wettability with organic electrolyte, which in turn, generates high ionic conduction resistance in the separator layers. The other limitation is a high static force that cause high pin-removal force during winding. Various attempts to improve these properties have been explored, such as the use of ceramic or polymer coating. The idea behind these attempts is that such ceramic or polymer coatings will improve ion transport and electrolyte uptake, decreasing ionic conduction resistance and static forces. Additionally, these ceramic or polymer coatings are believed to act as anti-blocking agents, which helps to minimize film to film surface contact, thereby minimizing adhesion. However, these approaches have only provided marginal improvements at an increased manufacturing cost.

As described herein, rather than applying an expensive, unprotected coating that is subject to damage, inorganic nanoparticles are blended with a polyolefin in a single step before formation of a membrane, and the inorganic nanoparticles and polyolefin are coextruded to make composite membranes. This approach not only improves ion transport and electrolyte uptake in the membrane, it does so at a much lower cost by achieving these properties without the need for an additional coating layer.

### I. Multilayer Membranes

In an aspect, a multilayer membrane comprises a first outer layer comprising a blend of a polypropylene (PP) and a first nanoparticle inorganic filler; a second outer layer laminated to the first outer layer. The polypropylene first outer layer can comprise a polypropylene (PE), a polypropylene blend, a polypropylene copolymer, or any combination thereof. In some embodiments, the second outer layer is a polyolefin composition comprising a polypropylene, a polypropylene blend, a polypropylene copolymer, a polyethylene, a polyethylene blend, a polyethylene copolymer, a polyvinylidene fluoride (PVDF), a polyethylene oxide (PEO), a poly(methyl methacrylate) (PMMA), or any combination thereof.

In some embodiments, the polyolefin can be an ultra-low molecular weight, a low-molecular weight, a medium molecular weight, a high molecular weight, or an ultra-high molecular weight polyolefin, such as a medium or a high weight polyethylene (PE) or polypropylene (PP). For example, an ultra-high molecular weight polyolefin can have a molecular weight of 450,000 (450 k) or above, e.g. 500 k or above, 650 k or above, 700 k or above, 800 k or above, 1 million or above, 2 million or above, 3 million or above, 4 million or above, 5 million or above, 6 million or above, etc. A high-molecular weight polyolefin can have a molecular weight in the range of 250 k to 450 k, such as 250 k to 400 k, 250 k to 350 k, or 250 k to 300 k. A medium molecular weight polyolefin can have a molecular weight from 150 to 250 k, such as 100 k, 125 k, 130K, 140 k, 150 k to 225 k, 150 k to 200 k, 150 k to 200 k, etc. A low molecular weight polyolefin can have a molecular weight in the range of 100 k to 150 k, such as 100 k to 125 k. An ultra-low molecular weight polyolefin can have a molecular weight less than 100 k. The foregoing values are weight average molecular weights. In some embodiments, a higher molecular weight polyolefin can be used to increase strength or other properties of the multilayer membranes or batteries comprising the same as described herein. In some embodiments, a lower molecular weight polymer, such as a medium, low, or ultra-low molecular weight polymer can be beneficial. For example, without intending to be bound by any particular theory, it is believed that the crystallization behavior of lower molecular weight polyolefins can result in a multilayer membrane having smaller pores resulting from at least a machine direction (MD) stretching process that forms the pores.

In some embodiment, a first nanoparticle inorganic filler described herein comprises CaSO₄, CaCO₃, TiO₂, SiO₂, SiO, or any combination thereof.

The first nanoparticle inorganic filler can have an average pore size of 2-15 nm, 3-15 nm, 4-15 nm, 5-15 nm, 6-15 nm, 7-15 nm, 8-15 nm, 9-15 nm, 10-15 nm, 11-15 nm, 12-15 nm, 13-15 nm, 14-15 nm, 2-14 nm, 2-13 nm, 2-12 nm, 2-11 nm, 2-10 nm, 2-9 nm, 2-8 nm, 2-7 nm, 2-6 nm, 2-5 nm, 2-4 nm, 2-3 nm, 2 nm, 3 nm, 4 nm, 5 nm, 6 nm, 7 nm, 8 nm, 9 nm, 10 nm, 11 nm, 12 nm, 13 nm, 14 nm, or 15 nm.

In some cases, a ratio of first nanoparticle inorganic filler polypropylene to comprises 0.1-10%, 0.3-10%, 0.5-10%, 0.7-10%, 1-10%, 1.5-10%, 2-10%, 2.5-10%, 3-10%, 3.5-10%, 4-10%, 4.5-10%, 5-10%, 5.5-10%, 6-10%, 6.5-10%, 7-10%, 7.5-10%, 8-10%, 8.5-10%, 9-10%, 0.1-9.5%, 0.1-9%, 0.1-8.5%, 0.1-8%, 0.1-7.5%, 0.1-6.5%, 0.1-6.5%, 0.1-6%, 0.1-5.5%, 0.1-5%, 0.1-4.5%, 0.1-4%, 0.1-3.5%, 0.1-3%, 0.1-2.5%, 0.1-2%, 0.1-1.5%, 0.1-1%, 0.1-0.7%, 0.1-0.5%, 0.1%, 0.3%, 0.5%, 0.7%, 1%, 1.5%, 2%, 2.5%, 3%, 3.5% 4%, 4.5% 5%, 5.5% 6%, 6.5%, 7%, 7.5%, 8%, 8.5%, 9%, 9.5%, or 10%, respectively.

The first nanoparticle inorganic filler can have an average size in three dimensions of 50-300 nm, 60-300 nm, 70-300 nm, 80-300 nm, 90-300 nm, 100-300 nm, 110-300 nm, 120-300 nm, 130-300 nm, 140-300 nm, 150-300 nm, 160-300 nm, 170-300 nm, 180-300 nm, 190-300 nm, 200-300 nm, 210-300 nm, 220-300 nm, 230-300 nm, 240-300 nm, 250-300 nm, 260-300 nm, 270-300 nm, 280-300 nm, 290-300 nm, 50-275 nm, 50-250 nm, 50-225 nm, 50-200 nm, 50-175 nm, 50-150 nm, 50-125 nm, 50-100 nm, 50-75 nm, 50 nm, 75 nm, 100 nm, 125 nm, 150 nm, 175 nm, 200 nm, 225 nm, 250 nm, 275 nm, or 300 nm.

In some instances, the blend of polypropylene and first nanoparticle inorganic filler is coextruded.

The second outer layer of the multilayer membrane in some embodiments comprises a polyolefin without any nanoparticle inorganic filler present. In other embodiments, the second outer layer can comprise a blend of a polyolefin and a second nanoparticle inorganic filler. In some instances, the second outer layer comprises a blend of a polypropylene and a second nanoparticle inorganic filler.

The first nanoparticle inorganic filler and the second nanoparticle inorganic filler can be of the same type in some instances, and in other instances the first nanoparticle inorganic filler and the second nanoparticle inorganic filler are different types. In some embodiments, the second nanoparticle inorganic filler comprises CaSO₄, CaCO₃, TiO₂, SiO₂, SiO, or any combination thereof.

In some cases, a multilayer membrane described herein can further comprise one or more inner layers positioned between the first outer layer and the second outer layer. In some instances, the multilayer membrane comprises 1, 2, 3, 4, 5, 6, 7, 8, 9, 10 or more inner layers. Each inner layer can independently comprise a polyolefin, such as a polyethylene, a polyethylene blend, a polyethylene copolymer, a polypropylene, a polypropylene blend, a polypropylene copolymer, a polyvinylidene fluoride (PVDF), a polyethylene oxide (PEO), a poly(methyl methacrylate) (PMMA), or any combination there.

In some embodiment, one or more inner layers are free of a nanoparticle inorganic filler. In other embodiments, one or more inner layers are blended with a nanoparticle inorganic filler, such as nanoparticle inorganic fillers comprising CaSO₄, CaCO₃, TiO₂, SiO₂, SiO, or any combination thereof. In some cases when a plurality of inner layers are present, one or more of the inner layers are free of the nanoparticle inorganic filler, and one or more of the inner layers are blended with the nanoparticle inorganic layer. When present in the inner layers, the nanoparticle inorganic filler can be present in an amount less than 10 wt. % based on a total weight of the inner layer.

In some embodiments, the one or more inner layers comprise one or more polypropylene inner layers positioned between the first outer layer and the second outer layer. In some cases, one or more of the polypropylene inner layers are free of a nanoparticle inorganic filler; and one or more of the other polypropylene inner layers are blended with a nanoparticle inorganic filler.

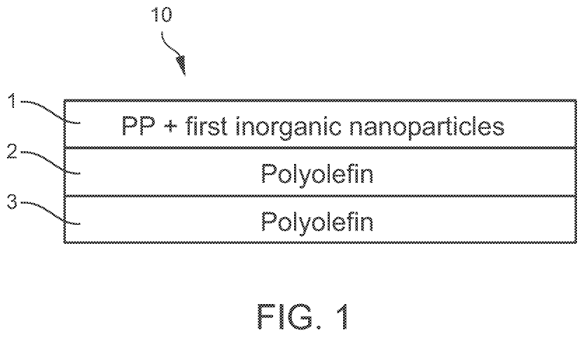

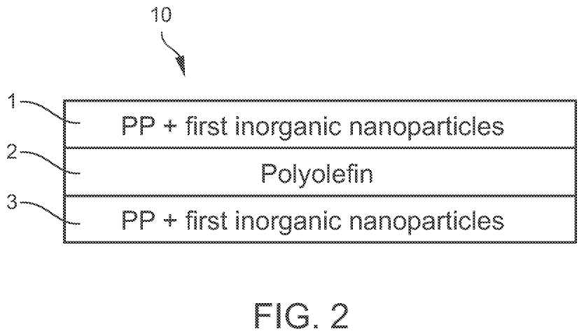

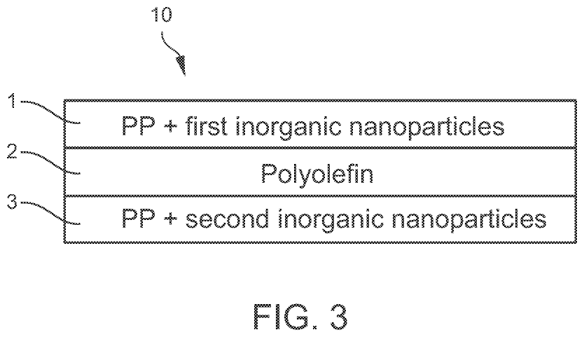

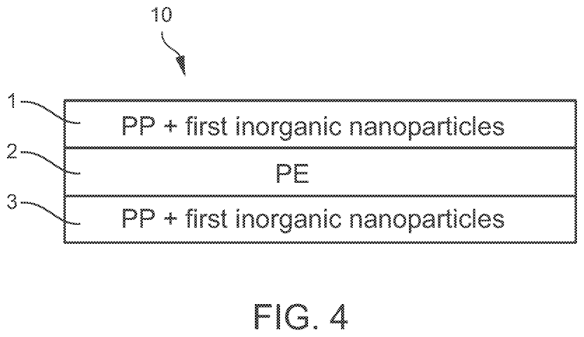

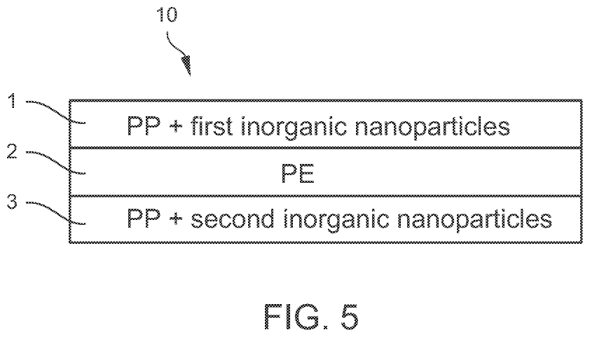

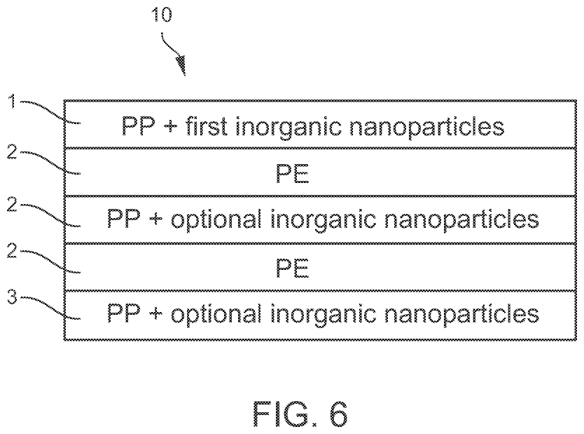

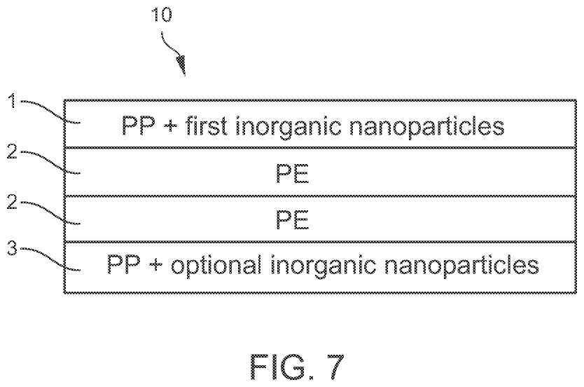

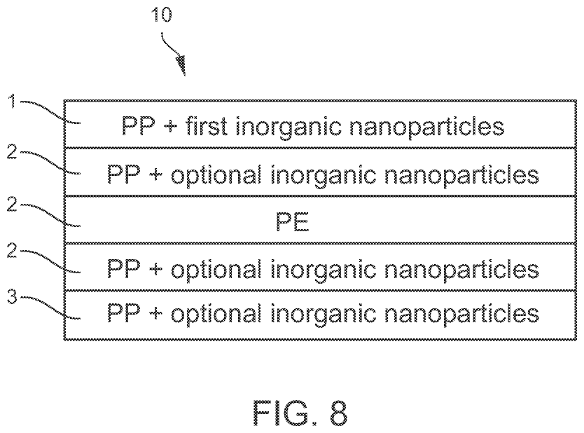

In some embodiments, multilayer membranes described herein have a multilayered structure of PP/PE/PP, PP/PE/PP/PE/PP, PP/PE/PE/PP, or PP/PP/PE/PP/PP. FIG. 1 shows an embodiment of a tri-layer membrane 10 having a first outer layer 1 comprising PP+first inorganic nanoparticles, an inner layer 2 comprising a polyolefin without any inorganic nanoparticles, and a second outer layer 3 comprising a polyolefin without any inorganic nanoparticles. FIG. 2 shows an embodiment where the first outer layer 1 and the second outer layer 3 both comprise PP+first inorganic nanoparticles, and an inner layer 2 comprising a polyolefin without any inorganic nanoparticles. FIG. 3 shows an embodiment where the first outer layer 1 comprises PP+first inorganic nanoparticles, an inner layer 2 comprising a polyolefin without any inorganic nanoparticles, and a second outer layer 3 that comprises PP+second inorganic nanoparticles, the first and second inorganic nanoparticles being different. FIG. 4 shows an embodiment where the first outer layer 1 and the second outer layer 3 both comprise PP+first inorganic nanoparticles, and an inner layer 2 comprising a PE without any inorganic nanoparticles. FIG. 5 shows an embodiment where the first outer layer 1 comprises PP+first inorganic nanoparticles, an inner layer 2 comprising PE without any inorganic nanoparticles, and a second outer layer 3 that comprises PP+second inorganic nanoparticles, the first and second inorganic nanoparticles being different. FIG. 6 shows a 5-layer embodiment comprising a structure of PP/PE/PP/PE/PP, where first outer layer 1 comprises PP+first inorganic nanoparticles, the PE/PP/PE inner layers 2 comprise a PP layer that optionally comprises first or second inorganic nanoparticles and two PE layers free of any inorganic nanoparticles, and a second outer layer 3 that comprises PP and optionally comprises first or second inorganic nanoparticles. FIG. 7 shows a 4-layer embodiment comprising a structure of PP/PE/PE/PP, where the first outer layer 1 comprises PP+first inorganic nanoparticles, the two PE inner layers 2 are free of inorganic nanoparticles, and the second outer layer 3 comprises PP and optionally comprises first or second inorganic nanoparticles. FIG. 8 shows a 5-layer embodiment comprising a structure of PP/PP/PE/PP/PP, where the first outer layer 1 comprises PP+first inorganic nanoparticles, the two PP inner layers 2 optionally comprise first or second inorganic nanoparticles, the PE inner layer 2 is free of inorganic nanoparticles, and the second outer layer 3 comprises PP and optionally comprises first or second inorganic nanoparticles. The embodiments shown in FIGS. 1-8 are meant to be exemplary, and should not be interpreted as being limiting. For example, while PE is used as an exemplary polyolefin, PE can be replaced with other polyolefins described herein.

Each layer described herein can be mono-extruded, where the layer is extruded by itself, without any sublayers. Alternatively, each layer can comprise a plurality of co-extruded sublayers. For example, a co-extruded bi-sublayer, tri-sublayer, or multi-sublayer membrane are each collectively considered to be a “layer”. The number of sublayers in coextruded bi-layer is two, the number of layers in a co-extruded tri-layer is three, and the number of layers in a co-extruded multi-layer membrane will be two or more, three or more, four or more, five or more, and so on. The exact number of sublayers in a co-extruded layer is dictated by the die design and not necessarily the materials that are co-extruded to form the co-extruded layer. For example, a co-extruded bi-, tri-, or multi-sublayer membrane can be formed using the same material in each of the two, three, or four or more sublayers, and these sublayers will still be considered to be separate sublayers even though each sublayer is made of the same material. Each layer comprising the co-extruded bi-, tri-, or multi-sublayer membranes can have a pre-stretched thickness of 1.2 mil or less, 1.1 mil or less, 1 mil or less, or 0.9 mil or less 0.8 mil or less, 0.75 mil or less, 0.5 mil or less, 0.4 mil or less, 0.3 mil or less, or 0.2 mil or less prior to stretching.

In some embodiments, the multilayer membrane or multilayer membrane disclosed herein comprises two, three, four or more co-extruded layers. Co-extruded layers are layers formed by a co-extrusion process. In some instances, the layers can be formed by the same or separate co-extrusion processes. The consecutive layers can be formed by the same co-extrusion process, or two or more layers can be coextruded by one process. Two or layers can be coextruded by a separate process, and the two or more layers formed by the one process can be laminated to the two or more layers formed by the separate process so that combined there are four or more consecutive coextruded layers. In some embodiments, the co-coextruded layers are formed by the same co-extrusion process. For example, two or more, or three or more, four or more, five or more, six or more, seven or more, eight or more, nine or more, ten or more, fifteen or more, twenty or more, twenty-five or more, thirty or more, thirty-five or more, forty or more, forty-five or more, fifty or more, fifty-five or more or sixty or more co-extruded layers can be formed by the same co-extrusion process. The extrusion process can also be performed by extruding two or more polymer mixtures, that can be the same or different, with or without a solvent. In some instances, the co-extrusion process is a dry process, such as Celgard® dry process, which does not use a solvent.

In some embodiments, the multilayer membrane described herein is made by forming a coextruded bi-layer (two coextruded layer), tri-layer (three coextruded layers), or multi-layer (two, three, or four or more co-extruded layers) membrane and then laminating the bi-layer, tri-layer, or multi-layer membrane to at least one or two other membranes. The other membranes can be a non-woven or woven membrane, mono-extruded membranes, or a co-extruded membranes. In some embodiments, the other membranes are co-extruded membranes having the same number of co-extruded layers as the co-extruded bi-layer, tri-layer, or multi-layer membranes. Moreover, each of the co-extruded layers can comprise two, three, four, or more sublayers, as previously described herein.

Lamination of the bi-layer, tri-layer, or multilayer co-extruded membrane with at least one other monolayer membrane or a bi-layer, tri-layer, or multi-layer membrane can involve use of heat, pressure, or heat and pressure.

In some instances, multilayer membrane described herein has a porosity in the range of 35-65%, 40-65%, 45-65%, 50-65%, 55-65%, 60-65%, 35-55%, 35-50%, 35-45%, 35-40%, 35%, 40%, 45%, 50%, 55%, 60%, or 65%.

The multilayer membrane can have any Gurley not inconsistent with the objectives of this disclosure, such as a Gurley that is acceptable for use as a battery separator. In some embodiments, the multilayer membrane or membrane described herein has a JIS Gurley (s/100 cc) of 150 or more, 160 or more, 170 or more, 180 or more, 190 or more, 200 or more, 210 or more, 220 or more, 230 or more, 240 or more, 250 or more, 260 or more, 270 or more, 280 or more, 290 or more, 300 or more, 310 or more, 320 or more, 330 or more, 340 or more, or 350 or more.

In some embodiments, the multilayer membrane described herein can comprise one or more additives in at least one layer of the multilayer membrane. In some embodiments, at least one layer of the multilayer membranes comprises more than one, such as two, three, four, five, or more, additives. Additives can be present in one or both of the outermost layers of the multilayer membrane, in one or more inner layers, in all of the inner layers, or in all of the inner and both of the outermost layers. In some embodiments, additives can be present in one or more outermost layers and in one or more innermost layers. In such embodiments, over time, the additive can be released from the outermost layer or layers and the additive supply of the outermost layer or layers can be replenished by migration of the additive in the inner layers to the outermost layers. In some embodiments, each layer of the multilayer membrane can comprise a different additive or combination of additives than an adjacent layer of the or each layer of the multilayer membrane.

In some embodiments, the additive comprises, consists of, or consists essentially of an ionomer. An ionomer, as understood by one of ordinary skill in the art is a copolymer containing both ion-containing and non-ionic repeating groups. Sometimes the ion-containing repeating groups can make up less than 25%, less than 20%, or less than 15% of the ionomer. In some embodiments, the ionomer can be a Li-based, Na-based, or Zn-based ionomer.

In some embodiments, the additives comprises cellulose nanofiber.

In some embodiments, the additive can comprise, consists of, or consist essentially of a lubricating agent. The lubricating agent or lubricant described herein is not so limited. As understood by one of ordinary skill in the art, a lubricant is a compound that acts to reduce the frictional force between a variety of different surfaces, including the following: polymer:polymer; polymer:metal; polymer; organic material; and polymer:inorganic material. Specific examples of lubricating agents or lubricants as described herein are compounds comprising siloxy functional groups, including siloxanes and polysiloxanes, and fatty acid salts, including metal stearates.

Compounds comprising two or more, three or more, four or more, five or more, six or more, seven or more, eight or more, nine or more, or ten or more siloxy groups can be used as the lubricant described herein. Siloxanes, as understood by those in the art, are a class of molecules with a backbone of alternating silicon atom (Si) and oxygen (O) atoms, each silicon atom can have a connecting hydrogen (H) or a saturated or unsaturated organic group, such as —CH₃ or C₂H₅. Polysiloxanes are a polymerized siloxanes, usually having a higher molecular weight. In some embodiments described herein, the polysiloxanes can be high molecular weight, such as ultra-high molecular weight polysiloxanes. In some embodiments, high and ultra-high molecular weight polysiloxanes can have weight average molecular weights ranging from 500,000 to 1,000,000.

The fatty acid salts described herein are also not so limited and can be any fatty acid salt that acts as a lubricant. The fatty acid of the fatty acid salt can be a fatty acid having between 12 to 22 carbon atoms. For example, the metal fatty acid can be selected from the group consisting of: Lauric acid, myristic acid, palmitic acid, stearic acid, oleic acid, linoleic acid, linolenic acid, palmitoleic acid, behenic acid, erucic acid, and arachidic acid. The metal can be any metal not inconsistent with the objectives of this disclosure. In some instances, the metal is an alkaline or alkaline earth metal, such as Li, Be, Na, Mg, K, Ca, Rb, Sr, Cs, Ba, Fr, and Ra. In some embodiments, the metal is Li, Be, Na, Mg, K, or Ca.

The fatty acid salt can be lithium stearate, sodium stearate, lithium oleate, sodium oleate, sodium palmitate, lithium palmitate, potassium stearate, or potassium oleate.

The lubricant, including the fatty acid salts described herein, can have a melting point of 200° C. or above, 210° C. or above, 220° C. or above, 230° C. or above, or 240° C. or above. A fatty acid salt such as lithium stearate (melting point of 220° C.) or sodium stearate (melting point 245 to 255° C.) has such a melting point. A fatty acid salt such as calcium stearate (melting point 155° C.) does not. The inventors of this application have found that calcium stearate is less ideal, from a processing standpoint, than other fatty acid metal salts, such as metal stearates, having higher melting points. Particularly, it has been found that calcium stearate could not be added in amounts above 800 ppm without what has been termed a “snowing effect” where wax separates and gets everywhere during a hot extrusion process. Without wishing to be bound by any particular theory, using a fatty acid metal salt with a melting point above the hot extrusion temperatures is believed to solve this “snowing” problem. Fatty acid salts having higher melting points than calcium stearate, particularly those with melting points above 200° C., can be incorporated in amounts above 1% or 1,000 ppm, without “snowing.” Amounts of 1% or above have been found to be important for achieving desired properties such as improved wettability and pin removal improvement.

In some embodiments, the additive can comprise, consist of, or consist essentially of one or more nucleating agents. As understood by one of ordinary skill in the art, nucleating agents are, in some embodiments, materials, inorganic materials, that assist in, increase, or enhance crystallization of polymers, including semi-crystalline polymers.

In some embodiments, the additive can comprise, consist of, or consist essentially of cavitation promoters. Cavitation promoters, as understood by those skilled in the art, are materials that form, assist in formation of, increase formation of, or enhance the formation of bubbles or voids in the polymer.

In some embodiments, the additive can comprise, consist of, or consist essentially of a fluoropolymer. The fluoropolymer is not so limited and in some embodiments is PVDF.

In some embodiments, the additive can comprise, consist of, or consist essentially of a cross-linker.

In some embodiments, the additive can comprise, consist of, or consist essentially of a lithium halide. The lithium halide can be lithium chloride, lithium fluoride, lithium bromide, or lithium iodide. The lithium halide can be lithium iodide, which is both ionically conductive and electrically insulative. In some instances, a material that is both ionically conductive and electrically insulative can be used as part of a battery separator.

In some embodiments, the additive can comprise, consist of, or consist essentially of a polymer processing agent. As understood by those skilled in the art, polymer processing agents or additives are added to improve processing efficiency and quality of polymeric compounds. In some embodiments, the polymer processing agent can be antioxidants, stabilizers, lubricants, processing aids, nucleating agents, colorants, antistatic agents, plasticizers, or fillers.

In some embodiments, the additive can comprise, consist of, or consist essentially of a high temperature melt index (HTMI) polymer. The HTMI polymer is not so limited and can be at least one selected from the group consisting of PMP, PMMA, PET, PVDF, Aramid, syndiotactic polystyrene, and combinations thereof.

In some embodiments, the additive can comprise, consist of, of consist essentially of an electrolyte additive. Electrolyte additives as described herein are not so limited as long as the electrolyte is consistent with the stated goals herein. The electrolyte additive can be any additive typically added by battery makers, particularly lithium battery makers to improve battery performance. Electrolyte additives must also be capable of being combined, such as miscible, with the polymers used for the polymeric membrane or compatible with the coating slurry. Miscibility of the additives can also be assisted or improved by coating or partially coating the additives. For example, exemplary electrolyte additives are disclosed in A Review of Electrolyte Additives for Lithium-on Batteries, J. of Power Sources, vol. 162, issue 2, 2006 pp. 13791394, which is incorporated by reference herein in its entirety. In some embodiments, the electrolyte additive is at least one selected from the group consisting of a solid electrolyte interphase (SEI) improving agent, a cathode protection agent, a flame retardant additive, LiPF₆ salt stabilizer, an overcharge protector, an aluminum corrosion inhibitor, a lithium deposition agent or improver, or a solvation enhancer, an aluminum corrosion inhibitor, a wetting agent, and a viscosity improver. In some embodiments the additive can have more than one property, such as it can be a wetting agent and a viscosity improver.

Exemplary SEI improving agents include VEC (vinyl ethylene carbonate), VC (vinylene carbonate), FEC (fluoroethylene carbonate), LiBOB (Lithium bis(oxalato) borate). Exemplary cathode protection agents include N,N′-dicyclohexylcarbodiimide, N,N-diethylamino trimethylsilane, LiBOB. Exemplary flame-retardant additives include TTFP (tris(2,2,2-trifluoroethyl) phosphate), fluorinated propylene carbonates, MFE (methyl nonafluorobuyl ether). Exemplary LiPF₆ salt stabilizers include LiF, TTFP (tris(2,2,2-trifluoroethyl) phosphite), 1-methyl-2-pyrrolidinone, fluorinated carbamate, hexamethyl-phosphoramide. Exemplary overcharge protectors include xylene, cyclohexylbenzene, biphenyl, 2, 2-diphenylpropane, phenyl-tert-butyl carbonate. Exemplary Li deposition improvers include AlI₃, SnI₂, cetyltrimethylammonium chlorides, perfluoropolyethers, tetraalkylammonium chlorides with a long alkyl chain. Exemplary ionic salvation enhancer include 12-crown-4, TPFPB (tris(pentafluorophenyl)). Exemplary Al corrosion inhibitors include LiBOB, LiODFB, such as borate salts. Exemplary wetting agents and viscosity diluters include cyclohexane and P₂O₅.

In some embodiments, the electrolyte additive is air stable or resistant to oxidation. A battery separator comprising the electrolyte additive disclosed herein can have a shelf life of weeks to months, e.g. one week to eleven months.

In some embodiments, the additive can comprise, consist of, or consist essentially of an energy dissipative non-miscible additive. Non-miscible means that the additive is not miscible with the polymer used to form the layer of the multilayer membrane or membrane that contains the additive.

Optionally in some embodiments, one or more coating layers can be applied to one or two sides of the multilayer membrane. In some embodiments, one or more of the coatings can be a ceramic coating comprising, consisting of, or consisting essentially of a polymeric binder and organic and/or inorganic particles. In some embodiments, only a ceramic coating is applied to one or both sides of the membrane. In other embodiments, a different coating can be applied to the membrane before or after the application of the ceramic coating. The different additional coating can be applied to one or both sides of the membrane or film also. In some embodiments, the different polymeric coating layer can comprise, consist of, or consist essentially of at least one of polyvinylidene difluoride (PVdF) or polycarbonate (PC).

In some embodiments, the thickness of the coating layer is less than about 12 μm, sometimes less than 10 μm, sometimes less than 9 μm, sometimes less than 8 μm, sometimes less than 7 μm, and sometimes less than 5 μm. In at least certain selected embodiments, the coating layer is less than 4 μm, less than 2 μm, or less than 1 μm.

The coating method is not so limited, and the coating layer described herein can be coated onto a porous substrate by at least one of the following coating methods: extrusion coating, roll coating, gravure coating, printing, knife coating, air-knife coating, spray coating, dip coating, or curtain coating. The coating process can be conducted at room temperature or at elevated temperatures.

The coating layer can be any one of nonporous, nanoporous, mesoporous or macroporous. The coating layer can have a JIS Gurley of 700 or less, sometimes 600 or less, 500 or less, 400 or less, 300 or less, 200 or less, or 100 or less.

The multilayer membrane can be stretched in a machine direction (MD) to make the multilayer membrane microporous. In some instances, the microporous multilayer membrane is produced by transverse direction (TD) stretching of the MD stretched microporous multilayer membrane. In addition to a sequential MD-TD stretching, the multilayer membrane can also simultaneously undergo a biaxial MD-TD stretching. Moreover, the simultaneous or sequential MD-TD stretched microporous multilayer membrane can be followed by a subsequent calendering step to reduce the membrane's thickness, reduce roughness, reduce percent porosity, increase TD tensile strength, increase uniformity, and/or reduce TD splittiness. In some embodiments, the multilayer membrane is TD stretched 1×, 2×, 3×, 4×, 5×, 6×, 7×, 8×, 9×, 10×, or more than 10×.

In an embodiment, a multilayer membrane can be manufactured using an exemplary process that includes stretching and a subsequent calendering step such as a machine direction stretching followed by transverse direction stretching (with or without machine direction relax) and a subsequent calendering step as a method of reducing the thickness of such a stretched membrane, for example, a multilayer porous membrane, in a controlled manner, to reduce the percent porosity of such a stretched membrane, for example, a multilayer porous membrane, in a controlled manner, and/or to improve the strength, properties, and/or performance of such a stretched membrane, for example, a multilayer porous membrane, in a controlled manner, such as the puncture strength, machine direction and/or transverse direction tensile strength, uniformity, wettability, coatability, runnability, compression, spring back, tortuosity, permeability, thickness, pin removal force, mechanical strength, surface roughness, hot tip hole propagation, and/or combinations thereof, of such a stretched membrane, for example, a multilayer porous membrane, in a controlled manner, and/or to produce a unique structure, pore structure, material, membrane, base film, and/or separator.

In some instances, the TD tensile strength of the multilayer membrane can be further improved by the addition of a calendering step following TD stretching. The calendering process typically involves heat and pressure that can reduce the thickness of a porous membrane. The calendering process step can recover the loss of MD and TD tensile strength caused by TD stretching. Furthermore, the increase observed in MD and TD tensile strength with calendering can create a more balanced ratio of MD and TD tensile strength which can be beneficial to the overall mechanical performance of the multilayer membrane.

The calendering process can use uniform or non-uniform heat, pressure and/or speed to selectively densify a heat sensitive material, to provide a uniform or non-uniform calender condition (such as by use of a smooth roll, rough roll, patterned roll, micro pattern roll, nano pattern roll, speed change, temperature change, pressure change, humidity change, double roll step, multiple roll step, or combinations thereof), to produce improved, desired or unique structures, characteristics, and/or performance, to produce or control the resultant structures, characteristics, and/or performance, and/or the like. In an embodiment, a calendering temperature of 50° C. to 70° C. and a line speed of 40 to 80 ft/min can be used, with a calendering pressure of 50 to 200 psi. The higher pressure can in some instances provide a thinner separator, and the lower pressure provide a thicker separator.

### II. Lithium Ion Battery

In an aspect, a lithium ion battery comprises a multilayer membrane described in Section I herein. In some embodiments, the multilayer membrane optionally comprises a coating layer on one or both sides of the membrane. The membrane itself, i.e., without a coating or any other additional components, exhibits the improved properties, such as improved thermal stability, increased film toughness, improved electrolyte uptake, and/or improved pin-removal properties. The performance of the membranes can be further enhanced by the addition of coatings or other additional components, or by the described machine direction (MD), MD-transverse direction (TD) or MD-TD-calendar (C) stretching.

### III. Vehicle or Device

In another aspect, a device comprises the lithium ion battery described in Section II herein. The lithium ion battery can comprise a multilayer membrane described in Section I herein, and one or more electrodes, e.g., an anode, a cathode, or an anode and a cathode, provided in direct contact therewith. The type of electrodes are not so limited. For example, the electrodes can be those suitable for use in a lithium ion secondary battery.

A suitable anode can have an energy capacity greater than or equal to 372 mAh/g, preferably ≥700 mAh/g, and most preferably 1000 mAH/g. The anode be constructed from a lithium metal foil or a lithium alloy foil (e.g. lithium aluminum alloys), a mixture of a lithium metal and/or lithium alloy and materials such as carbon (e.g. coke, graphite), nickel, copper, and the like, or from any other suitable anode material not inconsistent with the objectives of this disclosure.

A suitable cathode can be any cathode compatible with the anode and can include an intercalation compound, an insertion compound, or an electrochemically active polymer, or any other cathode materials not inconsistent with the objectives of this disclosure. Suitable intercalation materials includes, for example, MoS₂, FeS₂, MnO₂, TiS₂, NbSe₃, LiCoO₂, LiNiO₂, LiMn₂O₄, V₆O₁₃, V₂O₅, and CuCl₂. Suitable polymers include, for example, polyacetylene, polypyrrole, polyaniline, and polythiopene.

Any lithium ion battery described herein can be incorporated in any vehicle or device, e.g., an e-vehicle, or device, e.g., a cell phone or laptop, that is completely or partially battery powered.

### IV. Methods of Making Multilayer Membranes

In another aspect, a method of making a multilayer membrane described in Section I herein comprises extruding a dry process nonporous precursor blend of a polypropylene and a nanoparticle inorganic filler to form a first outer layer; extruding a dry process nonporous precursor polypropylene optionally comprising a blended nanoparticle inorganic filler to form a second outer layer; laminating the first outer layer to the second outer layer to form a nonporous laminated membrane precursor; annealing the nonporous laminated membrane precursor; and stretching the annealed nonporous laminated membrane precursor.

In some cases, a method of making a multilayer membrane described herein comprises extruding a dry process nonporous precursor blend of a polypropylene (PP) and a nanoparticle inorganic filler to form at least one outer layer; extruding a dry process nonporous inner layer precursor optionally comprising a blended nanoparticle inorganic filler to form an inner layer; laminating the outer layers to opposite sides of the one or more inner layers to form a nonporous laminated membrane precursor; annealing the nonporous laminated membrane precursor; and stretching the annealed nonporous laminated membrane precursor to form a laminated microporous multilayer battery separator membrane.

The inner layer precursor comprises polypropylene (PP), polyethylene (PE), polyvinylidene fluoride (PVDF), polyethylene oxide (PEO), poly(methyl methacrylate) (PMMA), or any combination there in some cases.

In some embodiments, a laminated multilayer membrane described herein produced by the methods described herein has a configuration of PP/PE/PP, PP/PE/PP/PE/PP, PP/PE/PE/PP, and/or PP/PP/PE/PP/PP.

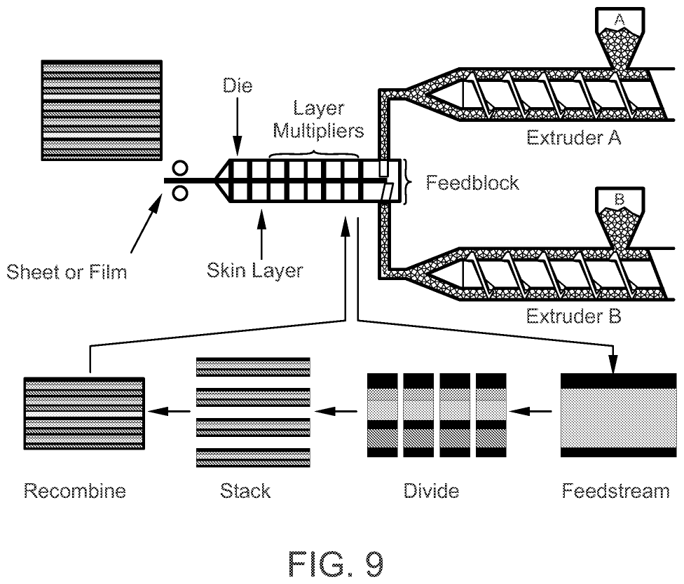

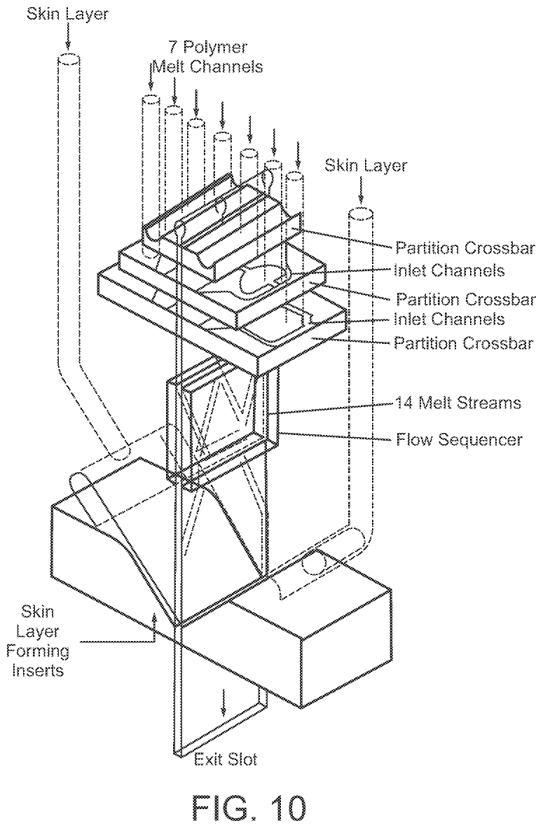

Co-extrusion typically involves use of a co-extrusion die with one or more extruders feeding the die (typically one extruder per layer of the bi-layer, tri-layer, or multi-layer membrane). An exemplary co-extrusion process is shown in FIG. 9 and a co-extrusion die is shown in FIG. 10.

In some embodiments, the co-extrusion step is performed using a co-extrusion die with one or more extruders feeding the die. Typically, there is one extruder for each desired layer or microlayer of the ultimately formed co-extruded film. For example, if the desired co-extruded film has three microlayers, three extruders are used with the co-extrusion die. In at least one embodiment the multilayer membrane can be constructed of many sublayers, microlayers, or nanolayers wherein the final product can contain 2, 3, 4, 5, 6, 7, 8, 9, 10, or more layers of individual sublayers, microlayers or nanolayers that together comprise a layer in the multilayer membrane. In at least certain embodiments the sublayer technology can be created by a pre-encapsulation feedblock prior to entering a cast film or blown film die.

In some embodiments, the co-extrusion is an air bubble co-extrusion method and the blow-up ration can be varied between 0.5 to 2.0, 0.7 to 1.8, or 0.9 to 1.5. Following co-extrusion using this blow-up ratio, the film can be MD stretched, MD stretched and then TD stretched (with or without MD relax) or simultaneously MD and TD stretched, as described in more detail below. The film can then be optionally calendered to further control porosity.

Co-extrusion benefits include but are not limited to increasing the number of layers (interfaces), which without wanting to be bound by any particular theory, is believed to improve puncture strength. Also, co-extrusion, without wishing to be bound by any particular theory, is believed to result in the observed DB improvement. Specifically, DB improvement can be related to the reduced PP pore size observed when a co-extrusion process is used. Also, co-extrusion allows for a wider number of choices of materials by incorporating blends in the microlayers. Co-extrusion also allows formation of thin tri-layer or multi-layer films (coextruded films). For example, a tri-layer co-extruded film having a thickness of 8 or 10 microns or thinner can be formed. Co-extrusion allows for higher MD elongation, different pore structure (smaller PP, larger PE). Co-extrusion can be combined with lamination to create desired inventive multi-layer structures. For, example, structures as formed in the Examples.

The laminating step comprises bringing a surface of the co-extruded film together with a surface of the at least one other film and fixing the two surfaces together using heat, pressure, and or heat and pressure. Heat can be used, for example, to increase the tack of a surface of either or both of the co-extruded film and the at least one other film to make lamination easier, making the two surfaces stick or adhere together better.

In some embodiments, the laminate formed by laminating the co-extruded film to at least one other film is a precursor for subsequent MD and/or TD stretching steps, with or without relax. In some embodiments, the co-extruded films are stretched before lamination.

Additional steps can comprise, consist of, or consist essentially of an MD, TD, or sequential or simultaneous MD and TD stretching steps. The stretching steps can occur before or after the lamination step. Stretching can be performed with or without MD and/or TD relax. Co-pending, commonly owned, U.S. Published Patent Application Publication No. US2017/0084898 A1 published Mar. 23, 2017 is hereby fully incorporated by reference herein.

Other additional steps can include calendering. For example, in some embodiments the calendering step can be performed as a means to reduce the thickness, as a means to reduce the pore size and/or porosity, and/or to further improve the transverse direction (TD) tensile strength and/or puncture strength of the porous biaxially stretched membrane precursor. Calendering can also improve strength, wettability, and/or uniformity and reduce surface layer defects that have become incorporated during the manufacturing process e.g., during the MD and TD stretching processes. The calendered film or membrane can have improved coat ability (using a smooth calender roll or rolls). Additionally, using a texturized calendaring roll can aid in improved coating adhesion to the film or membrane.

Calendering can be cold (below room temperature), ambient (room temperature), or hot (e.g., 90° C.) and can include the application of pressure or the application of heat and pressure to reduce the thickness of a membrane or film in a controlled manner. Calendering can be in one or more steps, for example, low pressure calendering followed by higher pressure calendering, cold calendering followed by hot calendering, and/or the like. In addition, the calendering process can use at least one of heat, pressure and speed to densify a heat sensitive material. In addition, the calendering process can use uniform or non-uniform heat, pressure, and/or speed to selectively densify a heat sensitive material, to provide a uniform or non-uniform calender condition (such as by use of a smooth roll, rough roll, patterned roll, micro-pattern roll, nano-pattern roll, speed change, temperature change, pressure change, humidity change, double roll step, multiple roll step, or combinations thereof), to produce improved, desired or unique structures, characteristics, and/or performance, to produce or control the resultant structures, characteristics, and/or performance, and/or the like.

### Example

### Physical Properties of Mono-PP Layer with SiO₂

A mono-polypropylene layer with 0.2 wt. % SiO₂ was prepared by blending PP with 0.2 wt. % and coextruding the blend to form a mono-PP layer. Table 1 shows the physical characteristics of the mono-PP-SiO₂ layer with a mono-PP layer free of SiO₂.

TABLE 1
Physical Properties of mono-PP-SiO2 layer verses mono-PP layer.

| | Unit | Control | Control + SiO₂ |
|---|---|---|---|
| Base weight avg | g | 0.67 | 0.65 |
| Thickness | μm | 14.7 | 14.7 |
| ER | Ωcm2 | 0.84 | 0.69 |
| Gurley | s | 203 | 190 |
| Porosity | % | 45.4 | 45.6 |
| Shrinkage 90 C. | % | 7.9 | 6 |
| Shrinkage 120 C. | μm | 14.2 | 13 |
| Puncture strength | gf | 243 | 224 |
| MD strength | kg/cm2 | 1544 | 1530 |
| TD strength | kg/cm2 | 144 | 157 |
| MD modulus | kg/cm2 | 7031 | 7862 |
| TD modulus | kg/cm2 | 2708 | 2971 |
| PP Pore size | μm | 0.039 | 0.043 |
| DB avg | volt | 1820 | 1700 |
| Shutdown temp | ° C. | 160 | 159 |
| Mix Penetration | N | 739 | 747 |

1. A multilayer battery separator comprising:
a first outer layer comprising a blend of a polypropylene and a first nanoparticle inorganic filler;
a second outer layer laminated to the first outer layer.

2. The separator of claim 1, wherein the first nanoparticle inorganic filler comprises CaSO₄, CaCO₃, TiO₂, SiO₂, SiO, or any combination thereof.

3. The separator of claim 2, wherein the first nanoparticle inorganic filler has an average pore size of 2-15 nm.

4. The separator of claim 1, wherein a ratio of first nanoparticle inorganic filler polypropylene to comprises 0.1-10%, respectively.

5. The separator of claim 1, wherein the first nanoparticle inorganic filler has an average size in three dimensions of 50-300 nm.

6. The separator of claim 1, wherein the first nanoparticle inorganic filler has an average pore size of 2-15 nm.

7. The separator of claim 1, wherein the blend of polypropylene and first nanoparticle inorganic filler is coextruded.

8. The separator of claim 1, wherein the second outer layer comprises a blend of a polypropylene and a second nanoparticle inorganic filler.

9. The separator of claim 8, wherein the second nanoparticle inorganic filler comprises CaSO₄, CaCO₃, TiO₂, SiO₂, SiO, or any combination thereof.

10. The separator of claim 8, wherein the first nanoparticle inorganic filler and the second nanoparticle inorganic filler are the same type.

11. The separator of claim 8, wherein the first nanoparticle inorganic filler and the second nanoparticle inorganic filler are different types.

12. The separator of claim 1, further comprising one or more inner layers positioned between the first outer layer and the second outer layer,
wherein at least one of the inner layers comprises a polypropylene, a polypropylene blend, a polypropylene copolymer, a polyethylene, a polyethylene blend, a polyethylene copolymer, a polyvinylidene fluoride (PVDF), a polyethylene oxide (PEO), a poly(methyl methacrylate) (PMMA), or any combination thereof.

13. The separator of claim 12, wherein the one or more inner layers are free of a nanoparticle inorganic filler.

14. The separator of claim 12, wherein the one or more inner layers are blended with a nanoparticle inorganic filler, with the nanoparticle inorganic filler being present in an amount less than 10 wt. % based on a total weight of the inner layer.

15. The separator of claim 1, wherein the one or more inner layers comprise one or more polypropylene inner layers positioned between the first outer layer and the second outer layer.

16. The separator of claim 15, wherein the one or more polypropylene inner layers is free of a nanoparticle inorganic filler; or
wherein the one or more polypropylene inner layers is blended with a nanoparticle inorganic filler.

17. The separator of claim 1, wherein the separator has a porosity in the range of 35% to 65%.

18. A method of making a multilayer battery separator comprising:
extruding a dry process nonporous precursor blend of a polypropylene (PP) and a nanoparticle inorganic filler to form a first outer layer;
extruding a dry process nonporous precursor polypropylene optionally comprising a blended nanoparticle inorganic filler to form a second outer layer;
laminating the first outer layer to the second outer layer to form a nonporous laminated membrane precursor;
annealing the nonporous laminated membrane precursor; and
stretching the annealed nonporous laminated membrane precursor.

19. A method of making a multilayer battery separator comprising:
extruding a dry process nonporous precursor blend of a polypropylene (PP) and a nanoparticle inorganic filler to form at least one outer layer;
extruding a dry process nonporous inner layer precursor optionally comprising a blended nanoparticle inorganic filler to form an inner layer;
laminating the outer layers to opposite sides of the one or more inner layers to form a nonporous laminated membrane precursor;
annealing the nonporous laminated membrane precursor; and
stretching the annealed nonporous laminated membrane precursor to form a laminated microporous multilayer battery separator membrane, wherein
the inner layer precursor may comprise a polypropylene, a polypropylene blend, a polypropylene copolymer, a polyethylene, a polyethylene blend, a polyethylene copolymer, a polyvinylidene fluoride (PVDF), a polyethylene oxide (PEO), a poly(methyl methacrylate) (PMMA), or any combination thereof, and
the laminated microporous multilayer battery separator may have a configuration of PP/PE/PP, PP/PE/PP/PE/PP, PP/PE/PE/PP, and/or PP/PP/PE/PP/PP.

20. (canceled)

21. (canceled)

22. A lithium ion battery comprising the membrane of claim 1.

23. (canceled)

24. A lithium ion battery comprising the membrane of claim 2.

25. A lithium ion battery comprising the membrane of claim 3.
